(19) United States
(12) Patent Application Publication
(10) Pub. No.: US 2020/0193281 A1
(43) Pub. Date: Jun. 18, 2020

(54) METHOD FOR AUTOMATING SUPERVISORY SIGNAL DURING TRAINING OF A NEURAL NETWORK USING BARCODE SCAN

(71) Applicant: Zebra Technologies Corporation, Lincolnshire, IL (US)

(72) Inventors: Sajan Wilfred, Kollam (IN); Robert James Pang, Williston Park, NY (US); Christopher J. Fjellstad, Smithtown, NY (US); Przemyslaw Kowalewski, Rocky Point, NY (US)

(21) Appl. No.: 16/218,969

(22) Filed: Dec. 13, 2018

(51) Int. Cl. G06N 3/08; G06K 7/14; G06N 3/04

(52) U.S. Cl. CPC G06N 3/08; G06N 3/0472; G06K 7/1482

(57) ABSTRACT

Techniques are provided for training a neural network, where the techniques include receiving image scan data of an object, such as a product or package presented at a scanning station, where the image scan data includes an image that contains at least one indicia corresponding to the object and physical features of the object. A neural networks examines the physical features and determines weighting indicating a correlation strength between the physical feature and an identification data of the object. Thereby training a neural network to identify objects from their scanned physical features in place or in accompaniment to scanned indicia data.

### BACKGROUND OF THE INVENTION

With increasing computing power, convolution neural networks (CNNs) have been used for object recognition in captured images. For a CNN to be effective, the input images should be of a sufficiently high quality, there is a need for correctness in training, and the layers and complexity of the neural network should be carefully chosen.

Typically, CNNs undergo supervised training, where information about the input images to the CNN is specified by some source, typically by a human. That is, with supervised training, typically someone must indicate to the CNN, what is actually contained in the input images. Because typical training requires large numbers of input images—the larger the number of training images, for example, the more effective the CNN training, generally speaking—supervised learning is a time consuming process. This is particularly true in environments where images are not standardized, for example, where images seemingly of the same general object or scene can contain vastly different, unrelated objects. Another issue with supervised training requirements for CNN is the lack of sufficient numbers of training input images of an object, or an imbalance in the number of training images, such that certain objects are represented in an imaging training set more often than other objects thus potentially skewing the training of the CNN.

CNN training is particularly painstaking in retail environments, where there are no known images (or image databases) for many of the items assigned a stock keeping unit (SKU).

One of the glaring ways in which the lack of sufficient CNN training techniques for retail products becomes apparent is with respect to spoofing. Spoofing is a process by which a customer or sales clerk attempts to transact an item at a barcode scanning station, not be scanning the barcode of the actual item, but by masking the barcode of the actual item, with a barcode from a less expensive item. The less expensive item is wrung up at the point of sale, and the customer is charged the corresponding price of the less expensive item, avoid the actual cost of the item.

Accordingly, there is a need for techniques for automating neural network training to accurately use barcode scanning

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram schematic of a system having a training mode for training a neural network and a spoofing detection mode for detecting an authorization transaction attempt, in accordance with some embodiments.

FIG. 2 is a schematic of an example training of a neural network for spoofing detection, in accordance with an example.

FIG. 3 is a schematic of another example training of a neural network with detection and removal of background image data, in accordance with an example.

FIG. 4 is a schematic of an example training of a neural network based in determined variations to previous trained image data, in accordance with an example.

FIG. 5 is a schematic of an example training of a neural network, in accordance with an example.

FIG. 6 is a flowchart of a method of training a neural network as may be performed by the system of FIG. 1, in accordance with some embodiments.

FIG. 7 is a flowchart of another method of training a neural network as may be performed by the system of FIG. 1, in accordance with some embodiments.

FIG. 8 is a flowchart of a method of detecting a spoofing attempt at the point of sale location of FIG. 1 and generating an alarm, in accordance with some embodiments.

FIG. 9 is a flowchart of a method of detecting a spoofing attempt at the point of sale location of FIG. 1 and overriding and authorizing a secondary transaction, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The present invention provides techniques to seamlessly take images of a product and scan those images for a barcode, as well as scan those images for physical features of an object in the image. The barcode data, once scanned and analyzed, can be compared against the physical features obtained for an object, and the data can be compared to determine if the two types of data correspond to the same object.

In various embodiments, the present invention is a method for training a neural network. The method, which is a computer-implemented method implemented on one or more processors, may include receiving, at one or more processors, image scan data. That image scan data may be of an object, such as a product or package presented at a point of sale, distribution location, shipping location, etc. The image scan data may be collected by an imaging device such as a barcode scanner with imaging reader, for example, or an imaging reader with a radio-frequency identification (RFID) tag reader. The image scan data may include an image that contains at least one indicia corresponding to the object as well physical features of the object. The indicia may be a barcode, a universal product code, a quick read code, or combinations thereof, for example. In various examples, the method further includes receiving, at the one or more processors, decoded indicia data for determining identification data for the object.

The method may further include correlating, at the one or more processors, at least a portion of the image scan data with that identification data to generate a correlated dataset. In various examples, the method includes transmitting, at the one or more processors, the correlated dataset to a machine learning frame, such as a neural network, which may perform a number of operations on the correlated dataset. In some examples, the neural network examines at least some of the physical features of the object in the correlated dataset and determines a weight for each of those physical features. These weights are a relative indication of a correlation strength between the physical feature and the identification data of the object. The method further includes generating or updating the neural network with the determined weights for assessing future image data against the weighted features.

In this way, in various examples, methods are provided for training a neural network to be able to identify and authenticate an object based on physical features of the object with a high degree of certainty. The identification of an object based on these physical features may then be compared against a second identification performed based on a scanned indicia. These two identifications may be compared against each to provide a multi-factor authentication of the scanned object for identifying improper scans, such as spoofing attempts at a point of sale.

In some examples, the method further includes the neural network updating a feature set for the object with the weights for at least some of the physical features; and deriving a characteristic set of physical features for the object based on the feature set.

In other examples, the present invention includes a system for training a neural network. The system may include a server communicatively coupled, via a communication network, to one or more object scanners, such as one or more barcode scanners with imaging readers or an imaging reader with a radio-frequency identification (RFID) tag reader. The server may be configured to receive image scan data from the object scanner, via the communication network, wherein the image scan data is of an object and wherein the image scan data includes at least one indicia corresponding to the object and wherein the image scan data further includes physical features of the object. The server may be further configured to receive decoded indicia data and determine an identification data for the object. The server may correlate at least a portion of the image scan data with the identification data for the object resulting in a correlated dataset; and the server may receive the correlated dataset to a neural network framework within the server. The neural network framework may examine at least some of the physical features of the object in the correlated dataset, and determine a weight for each of the at least some of the physical features of the object, where each weight is a relative indication of a correlation strength between the physical feature and the identification data of the object. The neural network framework may then generate or update a trained network model with the determined weights.

In some examples, the present invention includes a computer-implemented method for detecting spoofing. The method includes receiving, at one or more processors, image scan data, wherein the image scan data is of an object and includes physical features of the object and wherein the image scan data includes at least one indicia corresponding to the object and decoded indicia data for determining a first identification data for the object. The method further includes cropping, at the one or more processors, the image scan data to remove the at least one indicia from the image scan data to generate a indicia-removed image scan data; and providing, at the one or more processors, the indicia-removed image scan data to a neural network for examining the physical features of the object in the indicia-removed image scan data and determining a second identification data based on the physical features. The method further includes determining, at the neural network, a match prediction of the indicia-removed image scan data based on a comparison of the first identification data to the second identification data; and in response to the determination of the match prediction indicating a match, generating an authenticating signal, and in response to the determination of the match prediction indicating a non-match, generating an alarm signal.

In other examples, the present invention includes a system for detecting spoofing. The system includes a server communicatively coupled, via a communication network, to one or more object scanners, the server comprising one or more processors and one or more memories. The server may be configured to: receive, at one or more processors and from one of the object scanners, image scan data, wherein the image scan data is of an object and includes physical features of the object and wherein the image scan data includes at least one indicia corresponding to the object and decoded indicia data for determining a first identification data for the object; and crop, at the one or more processors, the image scan data to remove the at least one indicia from the image scan data to generate a indicia-removed image scan data. The server may be further configured to provide, at the one or more processors, the indicia-removed image scan data to a neural network for examining the physical features of the object in the indicia-removed image scan data and determine a second identification data based on the physical features; determine, at the neural network, a match prediction of the indicia-removed image scan data based on a comparison of the first identification data to the second identification data. The server may be further configured to, in response to the determination of the match prediction indicating a match, generate an authenticating signal, and in response to the determination of the match prediction indicating a non-match, generate an alarm signal.

In some examples, the present invention includes another computer-implemented method for detecting spoofing. That method includes receiving, at one or more processors, image scan data, wherein the image scan data is of an object and includes physical features of the object and wherein the image scan data includes at least one indicia corresponding to the object and decoded indicia data for determining a first identification data for the object; and cropping, at the one or more processors, the image scan data to remove the at least one indicia from the image scan data to generate a indicia-removed image scan data. The method further includes providing, at the one or more processors, the indicia-removed image scan data to a neural network for examining the physical features of the object in the indicia-removed image scan data and determining a second identification data based on the physical features; and determining, at the neural network, a match prediction of the indicia-removed image scan data based on a comparison of the first identification data to the second identification data. This method further includes, in response to the determination of the match prediction indicating a match, generating a first authenticating signal, and in response to the determination of the match prediction indicating a non-match, generating a second authenticating signal different than the first authenticating signal. For example, the method may include determining a priority difference between the first identification data and the second identification data; and generating the second authenticating signal as a signal authenticating a transaction corresponding to whichever of the first identification data and the second identification data has the higher priority. The method may further include identifying a priority heuristic; determining a priority difference between the first identification data and the second identification data based on the priority heuristic; and generating the second authenticating signal as a signal authenticating a transaction corresponding to whichever of the first identification data and the second identification data has the higher priority based on the priority heuristic.

In some examples, the present invention includes a system for detecting spoofing, where that system includes a server communicatively coupled, via a communication network, to one or more object scanners, the server comprising one or more processors and one or more memories. The server is configured to receive, at one or more processors, image scan data, wherein the image scan data is of an object and includes physical features of the object and wherein the image scan data includes at least one indicia corresponding to the object and decoded indicia data for determining a first identification data for the object; crop, at the one or more processors, the image scan data to remove the at least one indicia from the image scan data to generate a indicia-removed image scan data; and provide, at the one or more processors, the indicia-removed image scan data to a neural network for examining the physical features of the object in the indicia-removed image scan data and determine a second identification data based on the physical features. The server is further configured to determine, at the neural network, a match prediction of the indicia-removed image scan data based on a comparison of the first identification data to the second identification data; and in response to the determination of the match prediction indicating a match, generate a first authenticating signal, and in response to the determination of the match prediction indicating a non-match, generate a second authenticating signal different than the first authenticating signal, in a similar manner to the method described above and hereinbelow.

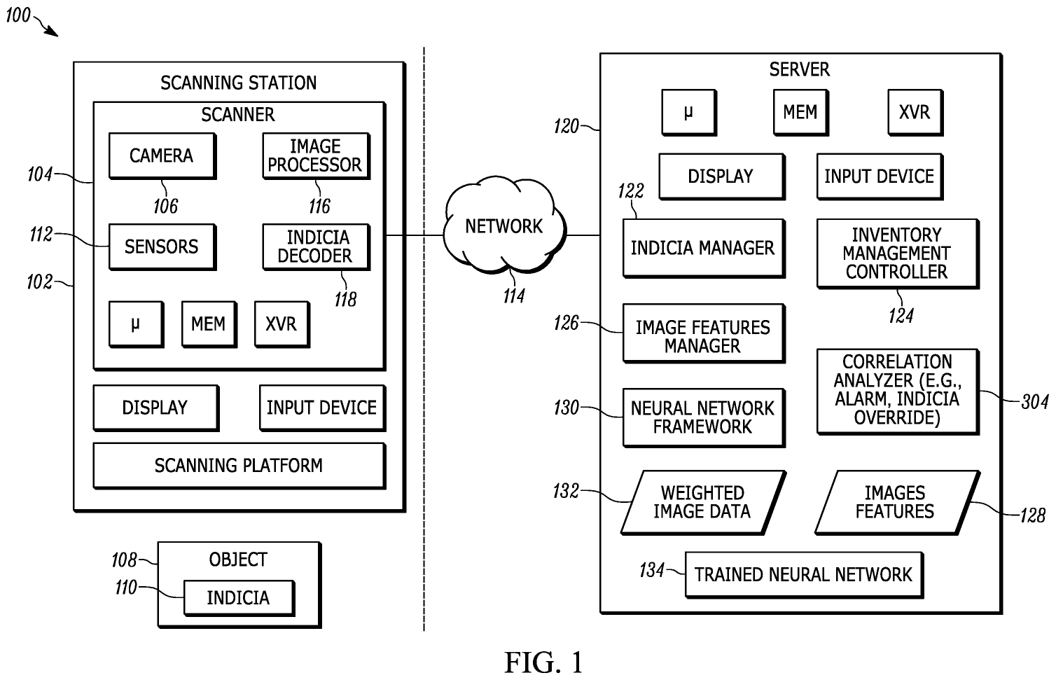

FIG. 1 illustrates an exemplary environment where embodiments of the present invention may be implemented. In the present example, the environment is provided in the form of a facility having a scanning location 100 where various goods may be scanned for training a neural network during a training mode and/or for scanning objects for purchase by a customer during a scanning authentication mode. In an example, the scanning authentication mode is a spoofing detection mode.

In the illustrated example, a point of sale location 100 includes a scanning station 102 having a scanner platform 103, e.g., a vertical and/or horizontal surface, and an object scanner 104 that includes a camera 106 and one or more sensors 108. The scanner 104 may be a handheld scanner, hands-free scanner, or multi-plane scanner such as a bioptic scanner, for example. The camera 106 captures image scan data of an object 108 bearing an indicia 110, where in some examples, the camera 106 is a 1D, 2D or 3D image scanner capable of scanning the object 108. In some examples, the scanner 104 may be a barcode image scanner capable of scanning a 1D barcode, QR code, 3D barcode, or other types of the indicia 110, as well as capturing images of the object 108 itself. In the illustrated example, the scanning station 104 includes sensors 112, which may include an RFID transponder for capturing indicia data is the form of an electromagnetic signal captured from the indicia 110 when the indicia 110 is an RFID tag, instead of an visual indicia, such as a barcode.

The scanner 104 also includes an image processor 116 and an indicia decoder 118. The image processor 116 may be configured to analyze captured images of the object 108 and perform preliminary image processing, e.g., before image scan data is sent to a server 120. In exemplary embodiments, the image processor 116 identifies the indicia 110 captured in an image, e.g., by performing edge detection and/or pattern recognition, and the indicia decoder 118 decodes the indicia and generates identification data for the indicia 110. The scanner 104 includes that identification data in the image scan data sent.

In some embodiments, the image processor 116 may be configured to identify physical features of the object 108, such as the peripheral shape of the object, the approximate size of the object, a size of the packaging portion of the object, a size of the product within the packaging (e.g., in the case of a packaged meat or produce), a relative size difference between a size of the product and a size of the packaging, a color of the object, packaging, and/or good, Point-of-Sale lane and store ID from where the item was scanned, shape of product, weight of product, variety of the product especially for fruits, and freshness of the product.

The scanner 104 includes one or more processors (“μ”) and one or more memories (“MEM”), storing instructions for execution by the one or more processors for performing various operations described herein. The scanner 104 further includes transceiver (“XVR”) for communicating image scan data, etc. over a wireless and/or wired network 114 to an anti-spoofing server 120. The transceiver may include a Wi-Fi transceiver for communicating with an image processing and anti-spoofing server 120, in accordance with an example. In some examples, the scanner 104 may be wearable device and include a Bluetooth transceiver, or other communication transceiver. The scanning station 102 further includes display for displaying scanned product information to a sales clerk, customer, or other user. The scanning station 102 may further include an input device for receiving further instructions from the user.

In exemplary embodiments, the image processing and anti-spoofing server 120 has at least two operating modes: a training mode for training a neural network of the server and a scanning authentication mode, for example a spoofing detection mode for detecting improper scanning of an object or indicia at the point of sale 100.

The server 120 includes one or more processors (“μ”) and one or memories (“MEM”), storing instructions for execution by the one or more processors for performing various operations described herein. The server 120 includes a transceiver (“XVR”) for communicating data to and from the scanning station 102 over the network 114, using a communication protocol, such as WiFi.

The server 120 includes an indicia manager 122, which may capture the identification data from the received image scan data and communicate that captured data to an inventory management controller 124 for identifying product data associated with the decoded indicia 110. In examples, where the image scan data does not include decoded identification data, the indicia manager 122 may perform the indicia decoding operations, described above as performed by the scanner 104. In other examples, one or more of the processes associated with indicia decoding may be distributed across the scanner 104 and the server 120.

The inventory management controller 124 takes the received identification data and identifies characteristic data (also termed herein product data) corresponding the indicia 110 and therefore corresponding to the object 108. Such characteristic data may include object name, SKU number, object type, object cost, physical characteristics of the object, and other information.

An imaging features manager 126 receives the image scan data from the scanner 104 and performs image processing to identify one or more physical features of the object 108, such as peripheral shape of the object, the approximate size of the object, a size of the packaging portion of the object, a size of the product within the packaging (e.g., in the case of a packaged meat or produce), a relative size difference between a size of the product and a size of the packaging, a color of the object, packaging, and shape of product. In other examples, the physical features may be determined wholly or partly at the image processor 116 and transmitted within the image scan data from the scanner 104 to the server 120.

In the exemplary embodiment, the imaging features manager 126 stores captured physical features of objects in an imaging features dataset 128. In some examples, the dataset 128 stores previously identified physical features, weighting factors for physical features, and correlation data for physical features, as discussed in further detail herein.

The indicia manager 122 and the imaging features manager 126 are coupled to a neural network framework 130 having a training mode and a spoof detection mode. As discussed herein, in various examples, in a training mode, the neural network frame 130 analyzes physical features of objects and determines weights for those physical features, where these weights provide a relative indication of how strong a correlation exists between the physical features and the identification data of the object. Physical features with higher weights are more likely correlating to a particular object (and therefore indicating the likely presence of that object in future image scan data), than physical features with lower weights. The neural network framework 130, for example, may be configured as a convolution neural network employing a multiple layer classifier to assess each of the identified physical features and to determine respective weights for each. Weight values for the physical features may be stored as weighted image data 132. From the determined weighted values, the neural network framework 130 generates and updates a trained neural network 134 for classifying subsequent image scan data and identifying the object or objects contained therein by analyzing the physical features captured in those subsequent images.

As described herein, the present techniques deploy a trained prediction model to assess received images of an object (with or without indicia) and classifier those images to determine a product associated with the object and product identification data, which is then used to prevent fraud attempts, such as spoofing. In some various examples herein, that prediction model is trained using a neural network, and as such that prediction model is referred to herein as a “neural network” or “trained neural network.” The neural network herein may be configured in a variety of ways. In some examples, the neural network may be a deep neural network and/or a convolutional neural network (CNN). In some examples, the neural network may be a distributed and scalable neural network. The neural network may be customized in a variety of manners, including providing a specific top layer such as but not limited to a logistics regression top layer. A convolutional neural network can be considered as a neural network that contains sets of nodes with tied parameters. A deep convolutional neural network can be considered as having a stacked structure with a plurality of layers. In examples herein, the neural network is described as having multiple layers, i.e., multiple stacked layers, however any suitable configuration of neural network may be used.

CNNs, for example, are a machine learning type of predictive model that are particularly using for image recognition and classification. In the exemplary embodiments herein, for example, CNNs can operate on 2D or 3D images, where, for example, such images are represented as a matrix of pixel values within the image scan data. As described, the neural network (e.g., the CNNs) can be used to determine one or more classifications for a given image by passing the image through the series of computational operational layers. By training and utilizing theses various layers, the CNN model can determine a probability that an image or physical image features belongs to a particular class. Trained CNN models can be persisted for restoration and use, and refined by further training. Trained models can reside on any in-premise computer volatile or non-volatile storage mediums such as RAM, flash storage, hard disk or similar storage hosted on cloud servers.

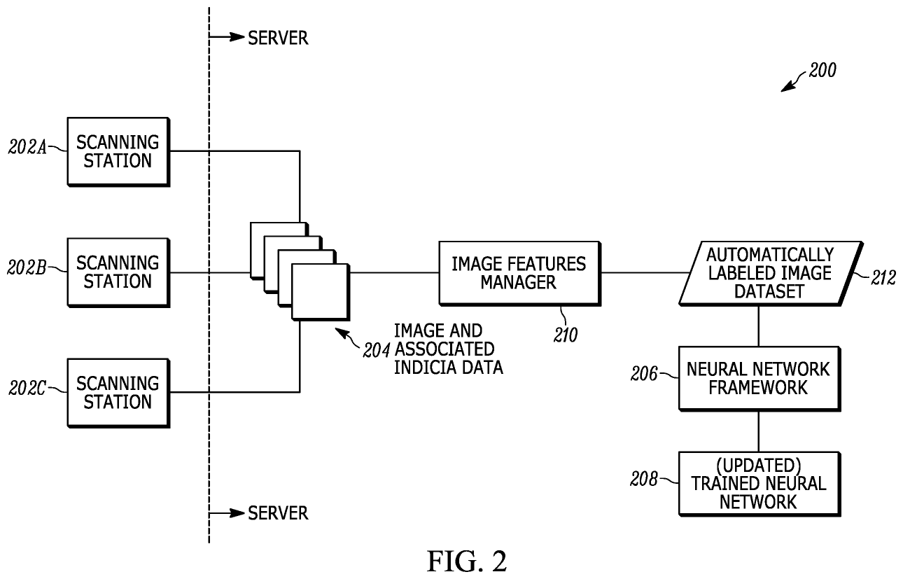

FIG. 2 illustrates a schematic 200 of a training mode in an example implementation. A plurality of scanning stations 202A-202C capture images of objects, performing preliminary image processing on those images, identify and decode indicia captured in the images of that objects, and package that information and image scan data that collectively represents a training set of image scan data 204. Each of the scanning stations 202A-202C may present a scanner at the same facility, such as a retail facility or warehouse, while in other examples the scanning stations 202A-202C may each be at a different facility located in a different location.

In an example of a training mode, each of the scanning stations 202A-202C captures images of the same object. For example, no matter where the scanning station is, the scanning station captures images of the same package for sale, and all the captured images of that package are collected in the training set of image scan data 204. For example, image scan data is communicated to a server, such as the server 120 and the server identifies received image scan data as corresponding to the same object by determining the decoded indicia in the received image scan data. In some examples, the server identifies a complete match between decoded indicia. In other examples, the server may still identify images as of the same object from partial identification of the decoded indicia, because not every image scan data from every scanning station may capture the full indicia in the image. In other examples, however, the server may collect all image scan data and instead of collectively grouping images together to form the training set 204, the server may allow a neural network 206 to use machine learning techniques to identify image scan data corresponding to the same object. In some examples, the server itself is configured to identify the indicia data in image scan data and to identify the location of that indicia data.

In the training mode, the scanning stations 202A-204C, although capturing images of the same object, capture those images from different angles and different orientations. Indeed, such diversity in the captured image scan data is valuable in developing a more robust trained neural network 208. Therefore, the training set 204 may comprise 100s, to 1000s, to 10000s or more images of an object many with great variation. Furthermore, the training set may grow over time, such that even after the trained neural network 208 has been generated during an initial execution of the training mode, as the same object is captured during retail transactions, for example, the captured images may be sent to the server for adding to the training set 204 and for eventual use by the neural network framework 206 in updating the trained neural network 208.

In the schematic 200, an image features manager 210 at the server identifies physical features, e.g., those listed elsewhere, for each of the image scan data in the training set 204 and generates a labeled image dataset 212 to the neural network framework 206. For example, some image scan data may include an overall shape of the outer perimeter of the object. Some image scan data may include only a portion of the outer perimeter, but may include an image of packaging label with the name of the product or the name of the manufacturer. Some image scan data may include images of packaging, such as a Styrofoam backing, and images of produce in that packaging. Some image scan data may include data on different colored portions of the object. Some image scan data may include a projected 3D volume of the object or a 2D surface area of the object, or a 2D surface area of a face of the object.

The images of each image scan data may then be labeled with an identification of the physical features identified by the manager 210. In some examples, the server generates the dataset 212 by correlating the identified physical features with identification data obtained from the decoded indicia data. That is, the dataset 212 includes image data labeled with both the identification data identifying the product contained within the object as well as the specific physical features capture by the scanner (3D volume, 2D surface area, etc.).

In the illustrated training mode, the neural network framework 206 examines the labeled image dataset 212, in particular the identified physical features, and determines a weight for each of those physical features of the object. These weights represent a relative indication of a correlation strength between the physical feature and the identification data of the object. For example, in an exemplary embodiment using a multi-layer classifier algorithm, the neural network framework 206 may determine that projected 3D volume is not highly correlative to predicting whether a captured image is of a box-shaped object. But the neural network framework 206 may determine that a physical feature of a white thinly backed object with red contrasting object on top thereof represent one or a series of physical features that are highly correlative with identifying the object, in this, as packaged meat produce. The neural network determines these weights for each of identified physical feature or for combinations of physical features, as a resulting of using the multiple-layer classifier algorithm. The neural network framework then initial generates the trained neural network 208 and updates an already existing trained neural network. In the illustrated example, the neural network 208 may be trained for identify anywhere from one to thousands of objects by physical features present in capture images of an object.

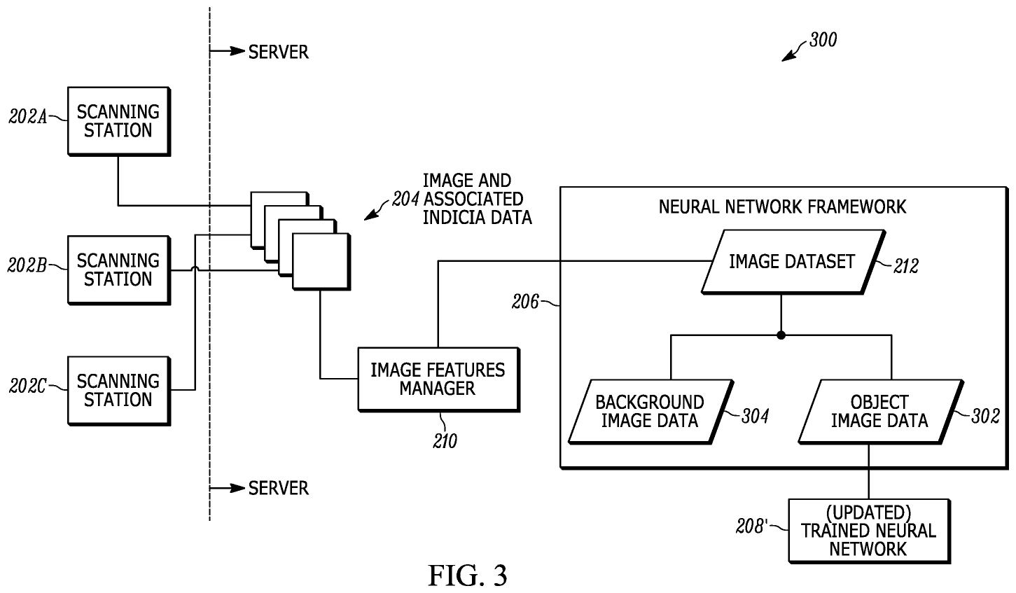

FIG. 3 illustrates another schematic 300 with like features to that of FIG. 2, but showing another example implementation of the training mode. In the schematic 300, the training image scan data 204 includes images of not only the object, but also where the images capture background of the area around the object where the scanning took place. For example, the captured background may include portions of a point of sale region of a retail facility.

In the example embodiment, the image features manager 210 identifies the physical features in the image scan data and sends the correlated image dataset 212 to the neural network framework 206, which analyzes that image dataset and identifies two types of information in that image dataset: object image data 302 and background image data 304. For example, the neural network framework 206 may compare received image dataset 212′ to previously received image scan data to identify anomalous features in the received dataset where those anomalous features correspond to background image data capture by the scanning station. Background image data may be particularly present in image scan data captured at the point of sale during a transaction, for example. Background image data may be any image data not identified as object image data. Examples, include portions of the environment around an object, equipment used at a Point-of-Sale station, the hand of scanning personnel, and other near-field and far-field image data. The neural network frameworks herein may be trained to identify such background image data; and, in some example, that training is ongoing during operation of the system thereby allowing the framework to adapt to changes in the environment within which the object is scanned. After identification of the background data 204 and the object image data 302, the neural network framework 206 strips away the former, and uses only the object image data 302 in updating the neural network 208′. Therefore, in this way, the neural network framework 206 may be trained to identify background image data that is not useful in identifying which object is captured by a scanner and remove that information. Indeed, the framework 206 may develop, through supervised or un-supervised techniques, classifiers for identifying background image data as more image scan data is collected over time.

In some examples, while the schematic 300 identifies background image data in images of a particular object or set of objects, the neural network framework 206 develops classifiers for identifying that background image data in any received image scan data, irrespective of what object is captured in that image data.

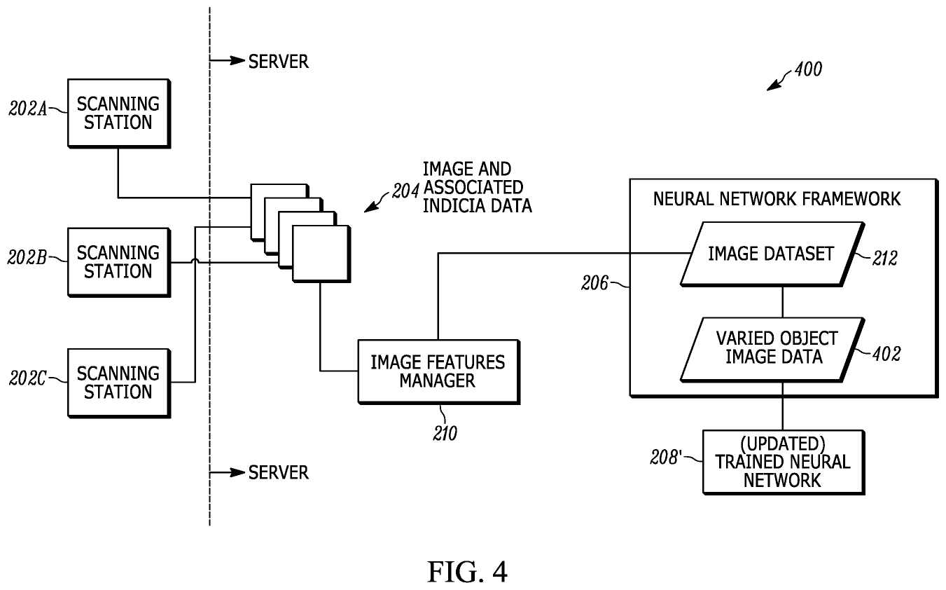

FIG. 4 illustrates another schematic 400 with like features to that of FIG. 2, but showing another example implementation of the training mode. In the schematic 300, the training image scan data 204 includes images of different versions of the same object. For example, the scanned object may be a drink bottle or a package of drink bottles. In some versions, the drink bottle has a regular version of its product label on the exterior of the bottle. But other versions, that product label may be changed, slightly or considerably, from that regular version. For example, the label may include special markings or changes for holiday versions of the drink bottle. In some versions, the actual bottle itself has changed from the regular bottle shape. In some versions, the bottle shape changes slightly over time. In any event, the image features manager 210 captures the image scan data.

In exemplary embodiments, the neural network framework 206 is trained to receive the image dataset 212 and identify only varied object image data, e.g., physical features that vary from expected physical features already correlated to the object identification data corresponding to the image scan data. For example, the server determines identification data for a scanned object from the decoded indicia. The server determines, from previously weights, which physical features are correlated to that identification data. The neural network framework 206 of the server then identifies, from the newly received image scan data, where variations in those physical features occur. The neural network framework 206, for example, may expect an outer 2D profile of a drink bottle to have a particular profile. The neural network framework 206 may use multi-layer classifiers to asses—a number of other physical features that confirm that received image scan data is of the drink bottle, but the neural network framework 206 may additional determine that the 2D profile of the drink bottle varies slightly, as might occur year to year from product changes or as might change seasonally. In such examples, the neural network framework 206 may identify only the varied object image data and use that data to update the trained neural network 208′.

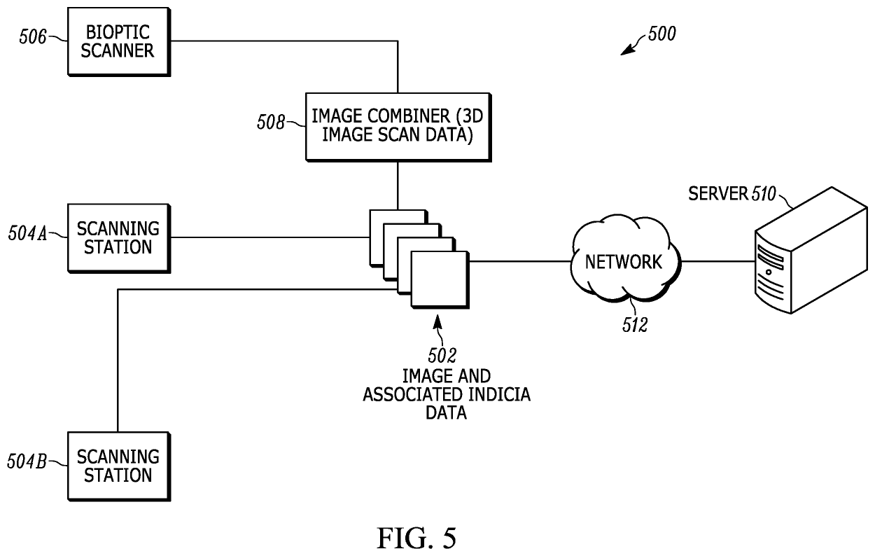

FIG. 5 illustrates a schematic 500 illustrating that image scan data 502 may contain 2D images from scanning stations 504A and 504B and 3D image scan data from a bioptic scanner 506 or other 3D imaging device. In an example, the bioptic scanner 506 captures multiple 2D images of the object and such 2D images are combined in an image combining processor device 508 to form a 3D image scan data. In the illustrated example, each of the scanning station 504A and 504B and the image combining processor device 508 communicate their respective image scan data to an image processing and anti-spoofing server 510 through network 512. As with the other examples herein the image processing and anti-spoofing server includes neural network framework.

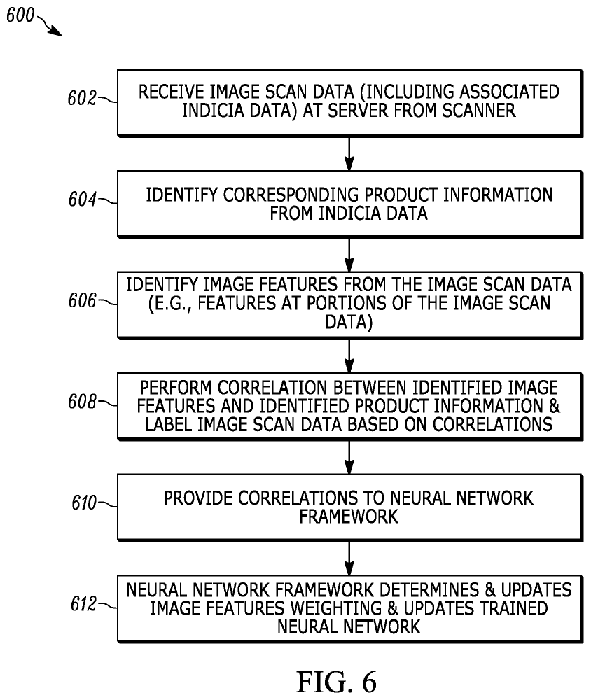

FIG. 6 illustrates a flowchart of a process 600 that may be performed during a training mode of the image processing and anti-spoofing system server 120. Image scan data of an object is received at a block 602, e.g., at the server 120 from the scanner 104. In the training mode, typically, the image scan data includes decoded indicia data corresponding to the object. At a block 604, the decoded indicia data is used to identify a corresponding product associated with that indicia data, e.g., by querying the inventory management controller 124, resulting in product identification data.

At a block 606, the imaging features manager 126 identifies physical features in the received image scan data. In other examples, the scanner or scanning station may determine physical features and send those to the server 120. The features may be identified over the entire image of the image scan data or only over a portion thereof. In some examples, the block 606 identifies physical features corresponding to a previously-determined set physical features. In some examples, the block 606 identifies all identifiable physical features. In some examples, the block 606 is configured to identify features in sequential manner and stops identifying physical features after a predetermined number of physical features have been identified. In some examples, the block 606 may be configured to identify features in an order correspondingly to previously-determined weights for the physical features. In any event, at the block 206, the imaging feature manager 126 may perform edge detection, pattern recognition, shape-based image segmentation, color-based image segmentation, or other imaging processing operations to identify physical features over all or portions of the image scan data. In some examples, the block 206 performs further image processing on these portions to determine physical features of the object, e.g., to reduce image noise.

In the example of produce as the scan object, such as meat contained in a freezer section of a retail store, the block 206 may identify a portion of image scan data, as the portion of the image scan data that includes the meat and excludes the portion of the image scan data that corresponds to a Styrofoam packaging of the meat. In other examples, the block 206 may identify the converse, i.e., the portion of the package, and not the product, for further analysis.

In some examples, the portion of the image scan data is a portion that includes all or at least a part of the indicia. In some examples, the portion of the image scan data includes portions that exclude the indicia, so that authentication that occurs in spoofing detection operates on non-overlapping data. In some examples, the image scan data is a 3D image data formed of a plurality of points with three-dimensional data and the portion of the image scan data is either a 2D portion of that 3D image data or a 3D portion thereof.

With the image scan data analyzed and the physical features identified, at a block 608, the physical features determined from the image data are correlated to product identification data obtained from the block 604, and that correlated data is sent to a neural network framework implementing block 610.

The neural network framework at block 612 develops (or updates) a neural network, in accordance with the example processes described herein. That is, in some examples, the neural network is configured to examine the physical features in the portion of the image scan data, and over a large training set of images, determine a weighting factor for one or more of those physical features, where the weighting factor is a relative value indicating the likelihood the physical feature can accurately identify the product from other products. For example, for produce, a physical feature, such as the overall size of a packaging or the color of packaging, may be determined to have a higher weighting factor compared to a physical feature such as length of the object or location of the indicia on the object. In some examples, the weighting factor may be determined for a collection of linked physical features, which may result in higher object identification accuracy.

In some examples, the training neural network from block 612 includes a characteristic set of physical features of the object, where this characteristic set presents the set of features the neural network has determined are minimally sufficiently predictive of the object. In some examples, this characteristic set may be a set provides object prediction with an accuracy of greater than 60%, greater than 70%, greater than 80%, greater than 90%, greater than 95%, or greater than 99%.

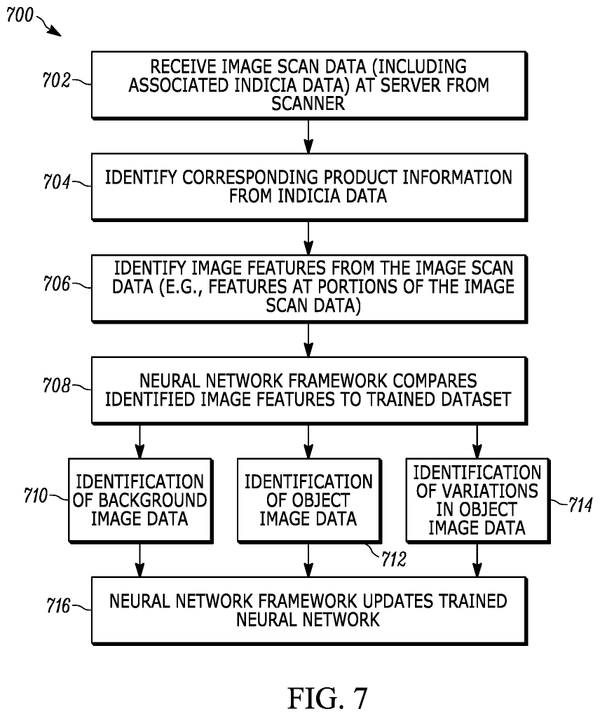

FIG. 7 illustrates another example implementation of the training mode as process 700. Image scan data is received, product identification data is determined from decoded indicia data, and physical features are identified from the images, at blocks 702, 704, and 706, respectively, and similar to that described for process 600. At a block 708, a neural network framework compares the identified physical features to previously identified image features in a trained data set, for example, applying a multi-layer classification process. From the comparison, the block 708 classifies image features into one of three classes: background image data 710, object image data 712, and variations to object image data 714. The classified image data types are sent to a block 716, where the neural network framework develops (or updates) a neural network, in accordance with the example processes described herein.

In another example, the scanning station 102 and the server 120 operate in a spoofing detection mode. With a neural network trained in accordance with the techniques herein, the spoofing detection mode is able to detect from image scan data when scanned image data does not correspond to scanned product identification data. In the spoofing detection mode, in an example implementation, the server 120 is able to authorize a transaction at the point of sale 100, send an alarm for to the scanning station 102 for an unauthorized transaction at the point of sale 100, or override the transaction and complete a secondary transaction in response to an unauthorized transaction at the point of sale 100.

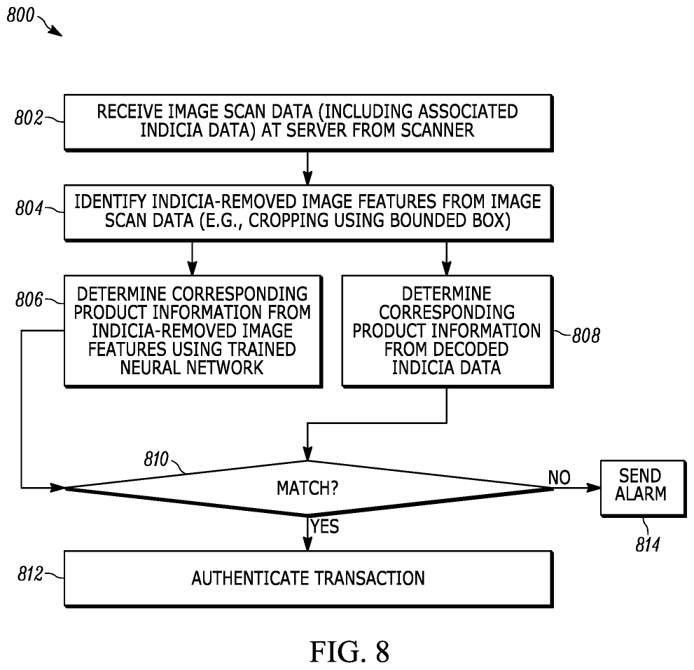

FIG. 8 illustrates an example spoofing detection process 800. An image processing and anti-spoofing server receives image scan data including decode indicia data at block 802. At a block 804, the server processes the received image scan data and identifies the indicia image in the image scan data and removes that indicia image from the scan data. The result is the block 804 produces images that have the indicia removed from them. This allows the anti-spoofing server to analyze image data independently from the indicia. In a typical spoofing attempt, a customer or sales representative attempts to replace the indicia, e.g., barcode, for a product with an indicia for a lower priced item, which is then charged to the customer to complete the transaction. In the process 800, however, at block 804, image data is generated where the indicia, such as an incorrect indicia, has been removed.

The block 804 then identifies image features in the images, to generate indicia-removed image features. That is, these may be image features determined from only that portion of the image scan data that contains image data on the object scanner and not on the indicia within the originally scanned image.

In an example, the indicia-removed image features are sent to a block 806 that determines corresponding product information from the image-removed image features, e.g., using the trained neural network and the weighted image features.

In the illustrated example, separately, decoded indicia data determined from the indicia scanned in the image is sent to a block 808, which separately identifies product information data based on the indicia. Therefore, product identification data is determined from two different data, indicia-removed image data and from decoded indicia data. In a spoofing attempt, the two different data will result in two different identified products. In the illustrated example of process 800, a block 810 determines if the two product identification data match, and if so the transaction is authenticated an authentication signal is communicated from the server to the scanning station via block 812. If there is not match, an alarm signal is generated by the server and sent to the scanning station via block 814.

In some examples, the block 810 generates a match prediction in the form of a match prediction score indicating a probability that the product information identified from the indicia-removed image features matches the product information identified from the decoded indicia data. In some examples, the match prediction is a percentage value.

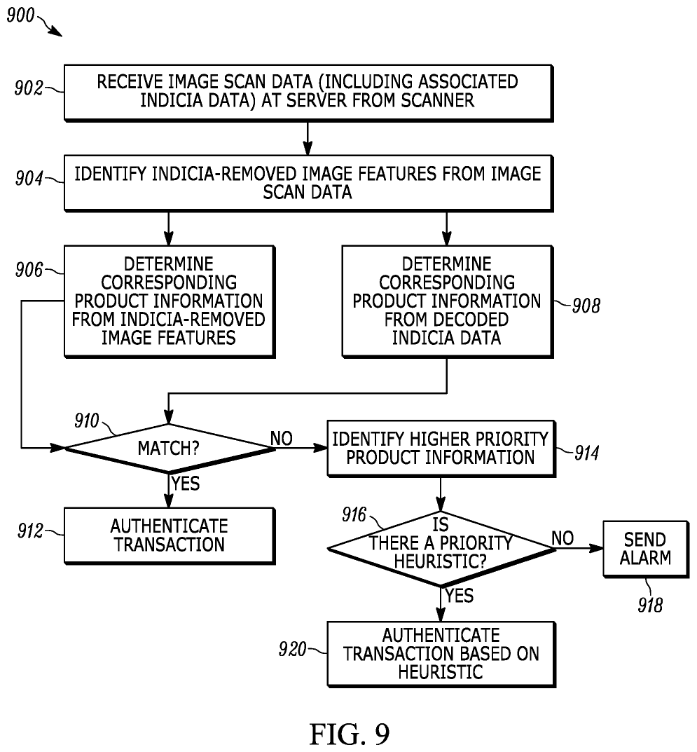

FIG. 9 illustrates another example spoofing detection process 900. Blocks 902, 904, 906, and 908 operate similarly to corresponding blocks in the process 800. At a block 910, an image processing and anti-spoofing server compares the two resulting product identification data and determines if there is a match. If there is a match, the transaction in authenticated and an authentication signal is sent from the server to the scanning station via a block 912. For example, the block 910 may generate a match prediction in the form of a match prediction score indicating a probability that the product information identified from the indicia-removed image features matches the product information identified from the decoded indicia data. In some examples, the match prediction is a percentage value.

The process 900 differs from the process 800, however, in that if a match does not occur, then the process 900 resolves the transaction instead of sending an alarm. In the illustrated example, at a block 914, the anti-spoofing server determines for each of the two identified product information data which product information has higher priority between the two. The priority of a product may be determined by accessing an inventory management controller and obtaining specific product data on the product. The priority of a product may be based on the price of a product, where the higher priced product has higher priority than the lower priced product. The priority of a product may be based on other product data, such as the amount of discounting of the price when the product is on sale. The priority may be based on other product data such as amount of remaining inventory on the product, whether the product may be re-shelved, traceability of the product, whether the product is perishable, whether the product is in high demand, a category classification of the product, such as whether the product is an essential household item or essential life sustaining item or household product vs. a non-essential home decor product, retailers margin on the product, traceability of the product (e.g. 1. a smart TV that requires geo activation is less likely to be stolen compared to one that does not have activation, 2. An RFID tagged apparel is less likely to be stolen compared to a non-RFID one as item could potentially be still tracked after sale).

Each of these priorities may be determined by applying a priority heuristic (e.g., high priced product wins priority, lower inventory product wins priority, perishable product wins priority). Such priority heuristics may be stored and executed at the server 120, for example. In the process 900, at a block 916, the server determines if a priority heuristic exists, and if one does not, then an ordinary alarm mode is entered and an alarm signal is sent from the server to the scanning station via block 918. For example, some retail store managers may send, over a communication network, an instruction to the anti-spoofing server to disable to priority heuristic so that transactions are not overridden.

In the illustrated example, when a priority heuristic does exist, at a block 920 the anti-spoofing server applies that priority heuristic, determines which product is to be charged at the point of sale, and then server authenticates the transaction based on that heuristic communicating transaction data, including an identification of the product and the product price to the scanning station for completely the transaction. In some examples, the anti-spoofing sever is send a transaction completion signal to the scanning station for automatically completing the transaction without further input from the customer, sales associate, etc. at the point of sale.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method for training a neural network, the method comprising:
receiving, at one or more processors, image scan data, wherein the image scan data is of an object and includes physical features of the object and wherein the image scan data includes at least one indicia corresponding to the object and decoded indicia data for determining an identification data for the object;
obtaining, at the one or more processors, the identification data for the object;
correlating, at the one or more processors, at least a portion of the image scan data with the identification data for the object resulting in a correlated dataset;
transmitting, at the one or more processors, the correlated dataset to a neural network framework; and
at the neural network framework,
examining at least some of the physical features of the object in the correlated dataset,
determining a weight for each of the at least some of the physical features of the object, where each weight is a relative indication of a correlation strength between the physical feature and the identification data of the object, and
generating or updating the neural network with the determined weights.

2. The computer-implemented method of claim 1, further comprising:
deriving, at the neural network, a characteristics set of physical features for the object based on the determined weights.

3. The computer-implemented method of claim 1, wherein the at least one indicia is a barcode, a universal product code, a quick read code, radio frequency identification code, or combinations thereof.

4. The computer-implemented method of claim 1, wherein the image scan data comprises a set of image frames captured of the object and of the at least one indicia.

5. The computer-implemented method of claim 4, wherein the set of image frames captured of the object and of at least one indicia are received from at least two or more imagers and captured at different angles.

6. The computer-implemented method of claim 1, further comprises:
determining, at the one or more processors, a product code associated with a product as the identification data for the object.

7. The computer-implemented method of claim 1, further comprising, at the neural network framework, determining if the object recognized by the physical features of image data set does not match the identification data determined from the at least one indicia.

8. The computer-implemented method of claim 1, wherein the neural network is a convolutional neural network.

9. The computer-implemented method of claim 1, further comprising;
at the neural network framework,
receiving subsequent image scan data comprising an image dataset having a plurality of image frames each containing object image data;
comparing the subsequent image scan data to trained image scan data and identifying object image data variations in the subsequent image scan; and
updating the neural network with the object image data variations.

10. The computer-implemented method of claim 1, further comprising;
at the neural network framework,
receiving subsequent image scan data comprising an image dataset having a plurality of image frames each containing object image data and background image data;
comparing the subsequent image scan data to trained image scan data, identifying the object image data and the background image data, removing the background image data, and generating a background-removed object image data set; and
training the neural network with the background-removed object image data set.

11. The computer-implemented method of claim 10, further comprising;
training the neural network framework to recognize background image data within image scan data.

12. The computer-implemented method of claim 11, wherein the background image data comprises hand image data.

13. A system for training a neural network, the system comprising:
a server communicatively coupled, via a communication network, to one or more object scanners, the server comprising one or more processors and one or more memories, the server configured to:
receive image scan data from the one or more object scanner, via the communication network, wherein the image scan data is of an object and includes physical features of the object and wherein the image scan data includes at least one indicia corresponding to the object and decoded indicia data for determining an identification data for the object;
obtain the identification data for the object determined from the decoded indicia data;
correlate at least a portion of the image scan data with the identification data for the object resulting in a correlated dataset; and
receive the correlated dataset to a neural network framework within the server and at the neural network framework,
examine at least some of the physical features of the object in the correlated dataset,
determine a weight for each of the at least some of the physical features of the object, where each weight is a relative indication of a correlation strength between the physical feature and the identification data of the object, and
generate or update the neural network with the determined weights.

14. The system of claim 13, wherein the server is configured to:
derive, at the neural network framework, a characteristics set of physical features for the object based on the determined weights.

15. The system of claim 13, wherein the at least one indicia is a barcode, a universal product code, a quick read code, radio frequency identification code, or combinations thereof.

16. The system of claim 13, wherein the image scan data comprises a set of image frames captured of the object and of the at least one indicia.

17. The system of claim 16, wherein the set of image frames captured of the object and of at least one indicia are captured at different angles.

18. The system of claim 13, wherein the server is configured to: determine, a product code associated with a product as the identification data for the object.

19. The system of claim 13, wherein the server is configured to, at the neural network framework, detect if the object recognized by the physical features of image data set does not match the identification data determined from the at least one indicia.

20. The system of claim 13, wherein the server is configured to: identify the at least one indicia data in the image scan data and identify the location of the at least one indicia data in the image scan data.
